(19) United States
(12) Patent Application Publication
(10) Pub. No.: US 2020/0345040 A1
(43) Pub. Date: Nov. 5, 2020

(54) CAPSAICIN NON-ALCOHOLIC CARBONATED BEVERAGE AND PROCESS FOR MAKING THE SAME THEREFROM

(71) Applicants: Richard H Selinfreund, La Cruces, NM (US); Paul Breslin, Pittsburgh, PA (US)

(72) Inventors: Richard H Selinfreund, La Cruces, NM (US); Paul Breslin, Pittsburgh, PA (US)

(21) Appl. No.: 16/855,254

(22) Filed: Apr. 22, 2020

Related U.S. Application Data
(60) Provisional application No. 62/839,360, filed on Apr. 26, 2019.

(51) Int. Cl. A23L 2/56; A23F 3/40; A23L 2/72; A23L 2/54; A23L 2/46; A23L 33/15; A23L 33/105

(52) U.S. Cl. CPC A23L 2/56; A23F 3/405; A23L 2/72; A23V 2002/00; A23L 2/46; A23L 33/15; A23L 33/105; A23L 2/54

(57) ABSTRACT

A capsaicin flavored non-alcoholic carbonated beverage product and to a process for producing such beverages is disclosed. The beverage comprises, an extract of capasicum-containing pepper, in addition to other ingredients. The extract is obtained by subjecting capasicum-containing peppers to a water extraction process at a sub-boiling point temperature.

### CROSS REFERENCE TO THE RELATED APPLICATION

This application claims the benefit of priority to U.S. provisional patent application 62/839,360, filed 26 Apr. 2019, entitled PROCESS FOR ENHANCED SHORT ACTING ON/OFF FLAVORING SENSATION OF BEVERAGES AND PRODUCT PRODUCED THEREFROM, the contents of which is hereby incorporated by reference herein in its entirety.

### FIELD OF THE INVENTION

The present invention is generally directed to a capsaicin flavored non-alcoholic carbonated beverage product and to a process for producing such beverages. The non-alcoholic carbonated beverages, includes sparkling waters, carbonated-teas, carbonated sodas. In general, the process includes the step of subjecting a capsaicin containing flavorant liquid, which may be carbonated or non-carbonated, is obtained by a water-based cayenne pepper extraction process. Such flavorant may be dehydrated and reduced to powder formulation for addition via sachet to the consumed the carbonated-water liquid.

### BACKGROUND OF THE INVENTION

Water Extracted Pepper Flavored beverages, such as flavored waters, sparkling waters, carbonated beverages, TEAs, and the like are generally produced through a flavoring process. Once produced, in order to improve the taste of the beverage, they may be flavored with a water based or ethanol-based flavorants. In the past, foods and beverages have been flavored with an oil-based pepper extract that produces slowly acting and long duration burning, hot, or warm sensations that persist for minutes to hours. To produce consistent heat upon sampling of beverages, manufacturers use analytical techniques that measure both water-based and organic extraction-based quantification of capsaicinoids. These techniques have changed little over the decade. Unfortunately, the process of oil-based extraction of pepper flavors can produce a long acting heat sensation that builds to a burning sensation in the mouth and subsequently in the esophagus. In the present invention we have developed a process and flavor package that imparts a rapid onset and offset of the heat sensation that imparts an enhanced flavor sensation restricted to the oral cavity. Furthermore, this water-based sensation tends not to grow cumulatively with repeated sampling, as oil-based extraction samples do. The taste enhanced process for refreshment of this new process provides for a rapid on and off heat.

To ensure product quality, pepper products are water extracted rapidly (multiple times) with extracts pooled by multiple extraction fractions and stored in frozen concentrates (10×) resulting in a product that may be stored under frozen conditions warehouses for very long periods of time (1 year). The concentrate may be frozen into pre-measured pepper concentrate blocks from a purchased pepper product at harvest that allows for extraction of the fresh taste of pepper products throughout the production year.

In addition, natural water extracted fresh peppers, extracted at sub-boiling temperatures, while providing the best method to date for enhancing and improving the flavor of beverages, also presents advantages over the chemical reactions which are believed to impair pepper flavor and quality. For instance, oxidation and esterification reactions which are believed to reduce taste quality are avoided with the rapid water extraction process. Due to the above deficiencies and disadvantages associated with conventional pepper extraction processes, those skilled in the art have attempted to devise processes for rapid extraction of a water-based fast acting pepper flavor for beverages. There is an added advantage that extraction temperatures below 45° C. can preserve both flavor and the structure of the natural vitamins and phytonutrients found in peppers. This low temperature extraction results in flavor enhanced beverages with a greater compliment of naturally occurring pepper-based nutrients and vitamins in the commercial product. For example, Non-hot paprika chiles (Capsicum annuum) are high in vitamins A (pro-vitamins), vit E, vit K, vit B6, and vit C and also contain iron, manganese, and potassium. In addition, chiles have high levels of carotenoids, including alpha- and beta-carotene, zeazanthin, crytpoxanthin (all pro-vitamin A) for immune, neural, and cranio-facial development; lutein for eye and brain development; and several red carotenoids for inhibition of toxic microbes. The Scoville scale was a measurement of the pungency or “heat” of peppers and spicy foods. Developed by Wilbur Scoville in 1912 is an organoleptic test (Scoville, Wilbur (May 1912). “Note on Capsicums”. Journal of the American Pharmaceutical Association. 1 (5): 453454. doi:10.1002/ips. 3080010520). “How Hot is That Pepper? How Scientists Measure Spiciness”. Smithsonian.com, US Smithsonian Institution. Retrieved 17 Dec. 2017). Today, high-performance liquid chromatography is employed to quantify capsaicinoid molecules as an analytical measurement of pungency (Guzman, I; Bosland, P. W (2017). “Sensory properties of chili pepper heat—and its importance to food quality and cultural preference” (PDF). Appetite. 117: 186-190. doi:10.1016/i.appet.2017.06.026. PMID 28662907 Collins M D, Wasmund L M, Bosland P W (1995). “Improved method for quantifying capsaicinoids in Capsicum using high-performance liquid chromatography”. HortScience. 30 (1): 137-139.

| EXAMPLE | SCOVILLE HEAT UNITS |
|---|---|
| Pure capsaicin | 18, [symbol] |
| U.S. grade police pepper spray | 2, [symbol] -5, [symbol] |
| Carolina Reaper | 1, [symbol] -2, [symbol] 000 |
| Trinidad moruga scorpion | 1, [symbol] -2, [symbol] |
| Bhut jolokia (ghost pepper) | 85 [symbol] -1, [symbol] |
| Red Savina habanero | 350,000-58 [symbol] |
| Habanero chile, Scotch bonnett | 3 [symbol] -35 [symbol] |
| Chiltepen | 58, [symbol] - [symbol] |
| Tabasco pepper | [symbol] - [symbol] |
| M [symbol] pepper, chile de [symbol] | 12, [symbol] -3x, [symbol] |
| Serrano pepper | 8,0 [symbol] -23, [symbol] |
| Chipotle pepper, jalapeño | 3,500-10,000 |
| Tabasco brand Original Red Sauce | 2,500-5,800 |
| Poblano [symbol] | 1, [symbol] -4, [symbol] |
| Paprika, pepperocini, pimento | [symbol] - [symbol] |
| Bell pepper | 0 |

[symbol]

indicates data missing or illegible when filed

The measurement of pepper heat profile on flavor has been broken down by Bosland and his colleagues at New Mexico State University (NMSU) into five categories: 1) how hot it is, 2) how fast the heat comes on, 3) whether it lingers or dissipates quickly, 4) where you sense the heat—on the tip of tongue, at the back of throat, etc., and 5) whether the heat registers as “flat” or “sharp.”

The problem of tasters fatigue in evaluating peppers has been solved by the development of Capsicum high-performance liquid chromatography process using alcohol-based extraction process. There is a commercial need to develop a water-based extraction methods for pepper enhanced foods and beverages that does not cause “tasters fatigue”.

A new process for commercial water extraction and analytical measurement for peppers that solves the problem of “tasters fatigue” and provides continued flavor enhancement of the product while being consumed is disclosed herein.

### BRIEF SUMMARY OF THE INVENTION

In an embodiment of the invention, a non-alcoholic sparkling beverage is disclosed. The beverage comprises, an extract of capasicum-containing pepper, in addition to other ingredients. The extract is obtained by subjecting capasicum-containing peppers to a water extraction process at a sub-boiling point temperature. The beverage may be tea, soda, sparkling water, energy drink, sports drink, or other flavored drink.

In another embodiment of the invention, a process for preparing a non-alcoholic beverage containing an extract of capasicum-containing pepper is disclosed. The process comprises the steps of 1) preparing a stock beverage, 2) extracting capsaicinoids and pepper-derived phytochemicals using a water extraction method, 3)infusing said capsaicinoids and said pepper-derived phytochemicals into said stock beverage to form a flavor enhanced beverage, 4) filtering said flavor enhanced beverage to remove particulate matter, 5) bottling and carbonating said flavor enhanced beverage, and 6) pasteurizing said flavor enhanced beverage.

In a non-limiting example of the first step, preparing the stock beverage, tea may be prepared by any of the conventional tea brewing processes. Tea leaves, or portions thereof, may be immersed in water and allowed to brew. The temperature of the water may affect the flavor of the resulting tea beverage. Both hot water brewing and cold water brewing (i.e., brewing at a water temperature below the boiling point) are envisioned as variants for this process step. Additional flavorings and sweeteners may be added at this step.

In the second and third steps, the brewed tea is brought to a capasicum extraction temperature and capasicum containing peppers are added to the brew. The brew is given sufficient time to allow the capasicum to infuse into the tea. The selection of the extraction temperature is a tradeoff between process speed and taste. Lower temperature extraction improves flavor of the beverage.

In the fourth step, the brew is next filtered to remove all particulate matter.

In the fifth and sixth steps, the filtered brew is carbonated, bottled and pasteurized.

In other non-limiting examples, sodas or sparkling water drinks (flavored and unflavored) may be prepared.

### DESCRIPTION OF THE INVENTION

In a first embodiment of the invention, a non-alcoholic sparkling beverage is disclosed. The beverage may be a carbonated tea, sparkling water, carbonated soda, carbonated energy drink, or carbonated sports drink. Each of these beverages comprises flavorings that include extract of capsicum containing pepper. Specifically, the extraction process must employ water at sub-boiling point temperatures.

In a second embodiment of the invention, a process for preparing the non-alcoholic beverage is disclosed. The process may comprise the following steps:
Step 1) Prepare a stock beverage. Non-limiting examples of suitable stock beverages may be any of tea, sports drink, energy drink, sparkling water, soda, re-hydration beverage, or caffeinated drink.
Step 2) Extract capsaicinoids and pepper-derived phytochemicals using a water extraction method. After bringing stock beverage to the extraction temperature, peppers containing capsaicinoids and phytochemicals are introduced into the stock beverage. In some embodiments the extraction temperatures are in the range of 60 degrees F. to 212 degrees F. In a desirable embodiment, the extraction temperatures are in the range of 80 degrees F. to 130 degrees F. In a more desirable embodiment, the extraction temperatures are in the range of 90 degrees F. to 120 degrees F. One important aspect of the present invention is the amount of pre-determined heat value of the pepper that is added to the water volume. For instance, for most applications, the amount of material to produce Mild, Medium and Extra Hot flavor must be held consistent:
   For Mild 20 grams of Poblano type pepper added to water with a Capsaicin levels between 5-10 SHU's/20 grams;
   For Medium 20 grams of starting material 5-20 SHU's particularly at least 15 Water Extracted SHU's per 20 gram of material.
   For Hot 20 grams of hot starting material 120-150 SHU's.
Step 3) Infuse capsaicinoids and pepper-derived phytochemicals into stock beverage to form flavor enhanced beverage. Generally, the pepper can be extracted between 3-8 minutes. In one non-limiting embodiment, the pepper material can be contacted with the water for between about 4 min and about 36 hours depending on temperature.
Step 4) Filtering and purifying flavor enhanced beverage to remove particulate matter. In one embodiment, the extract can be contacted with a purifying agent before, during, and/or after the present process. For example, the flavor-enhanced beverage can be contacted with activated carbon, diatomaceous earth, a filter, or a combination of purifying elements. A filter having an average pore size of less than about 5 p.m. can be used either alone or with other purifying agents to purify to remove particulate from the peppers.
Step 5) bottling and carbonating said flavor enhanced beverage; and
Step 6) pasteurizing said flavor-enhanced beverage.

Examples of possible flavorants can include the pepper family (Piperaceae) including Capsicum; Solanaceae, including but not limited to:

The genus Piper of the pepper family (Piperaceae), including for example:
Black pepper, white and green pepper, Piper nigrum
Cubeb, Piper cubeba, also known as Java pepper
Indian long pepper, Piper longum
Indonesian long pepper, Piper retrofractum
Voatsiperifery, Piper borbonense
Ashanti pepper, Piper guineense

The genus Capsicum of the nightshade family (Solanaceae), including for example:
Banana pepper. Capsicum annuum cultivars
Bell pepper. Capsicum annuum cultivars
Cayenne pepper. Capsicum annuum cultivars
Chili pepper. a number of species
Datil pepper, a Capsicum chinense cultivar
Jalapeno. a Capsicum annuum cultivar
Florina pepper. a Capsicum annuum cultivar

The genus Pimenta of the myrtle family (Myrtaceae). including for example:
Allspice (P. dioicia)
Pimenta haitiensis
Pimenta jamaicensis
Pimenta obscura
Pimenta racemosa. West Indian bay tree

Several plants known as Red pepper (disambiguation)
Chili powder. a finely ground mixture of dried chili peppers
Crushed red pepper. a coarsely crushed mixture of dried chili peppers
Chili peppers that are red. especially:
Cayenne pepper
Bell pepper. has various colors including red
Red Savina pepper. a cultivar of the habanero chili

Other plants known as peppers:
Aframomum melesueta. grains of paradise
Alligator pepper
Embelia ribes. false black pepper
Macropiper excelsum. kawakawa
Pepper dulse. Osmundea pinnatifida. a red seaweed
Pseudowintera. horopito
Pseudowintera colorata. New Zealand pepperwood
Pickled pepper
Genus Schinus. peppercorn trees
“Pink peppercorns”. obtained from Schinus molle
Tasmanian pepper. mountain pepper or “pepperbush”. Tasmannia species
Vitex asnus-castus. monk's pepper
Water pepper. Persicaria hydropiper
Genus Zanthoxylum
Sichuan pepper. produced from the fruit of several Zanthoxylum species
Zanthoxylum clava-herculis. American pepperwood

The process of the present invention can produce flavor in beverages while requiring far less flavorants, for example, less pepper seasonings, while producing the same quality of flavor as other flavoring processes. The process of the present invention is economical and does not require a substantial amount of labor or equipment. The process of the present invention is also easily controllable for producing beverages with uniform characteristics. The process can be configured either as a continuous process or as a batch process, as desired. A non-exhaustive list of examples of water-based beverages include but are not limited to: still and carbonated bottled waters, sodas, teas, spritzers, re-hydration drinks, energy drinks, sports drinks that increase perception of staying hydrated.

The process of the present invention can be performed in either a batch or continuous operation. For descriptive purposes only, the process has been divided into three separate stages, only the first of which is required by the present process. It should be understood, however, that the ‘stages’ described need not be carried out separately, and can all be combined in one continuous process operation.

The beverages of the present invention can be improved by processing via only the first stage extraction, the first and second stage extraction of the same pepper material, or via all three stages extractions, the following is a detailed description of each stage that may occur during the process. The perception of heat(pungency) values in sensory evaluation seemed much hotter (much more pungent) than the HPLC predicted Scoville value. The duration of the pungent sensation was less than that of a normal pepper or sauce sensation. The sensation also dissipated faster than that of a pepper or sauce.

### Stage I

In Stage I, the frozen pepper feed stock is placed in a vessel and subjected to water extraction. If desired, a catalyst can be added to the feed stock. In one embodiment, the water-extracted pepper can be recirculated through the vessel during this stage. During this stage, which can be a stand-alone process, the heat and flavor of the beverage stock can be significantly improved.

The size of the reactor vessel that is used can vary depending upon the particular process and is generally not critical. In one embodiment, during this stage of the process, the extract can be brought into contact with various purifying elements in order to remove undesirable impurities contained within the beverage. Such purifying elements can include, for instance, activated charcoal, physical filtering elements, including those with filtration pores of an average diameter down to the micron scale, and/or diatomaceous earth. In addition to removing impurities, the purifying elements can also improve the color and clarity of the product. One embodiment of the present invention uses filtration elements in series with both mineral and fiber filtration processes. It one embodiment a hotter pepper may be employed at a larger dilution to provide a mild product based on dilution factors.

As shown above, the process of the present invention is capable of using natural ingredients rather than using extracts, although extracts or concentrates may optionally be used in the process. Further, it should be understood that the particular flavorants used in any particular process will depend upon the product that is being produced. Consequently, a single flavorant extract or a mixture of pepper flavorants may be combined as appropriate.

In those embodiments wherein the flavorants are in solid form, i.e. preferably dried or fresh flavorants or frozen as opposed to liquid extracts or concentrates. Any suitable filter may be used for this purpose. For instance, a micron sized fabric filter may be used. The mixture may also be cold filtered.

Further, it has been discovered that by selecting various combination of flavorants, not only are desirable flavors enhanced, but undesirable flavors can be masked and the causative undesirable flavorants can be reduced in amount.

In Stage III of the process of the present invention, which is optional after any solid flavorants of Stage II have been removed, Stage III is not time dependent, but for most applications, can last from about 3 minutes to about 6 hours. Longer times may be used if desired. During this part of the process, the beverage can also be further filtered in order to ensure that no particulate material remains in the liquid, as well as to improve clarity to commercial standards. Alternatively, or in addition to filtering the beverage during Stage III of the process, the beverage can be filtered.

In combination with the present process, other known processing techniques can be included in formation of the desired beverage. For example, other existing commercial processes such as microoxidation, recirculation in oxygen enhanced or deprived conditions, coloration, polish filtration, or inclusion of other additives to the product may be incorporated into the present process. Such known processes can be incorporated with the present invention to achieve specific desired effects in the product beverage, for example desired natural flavors or colors associated flavor, clarity, or aroma desired in the product, and the like.

It has been discovered that the heat extracted flavor produced by the present process will not decay over time, even under unfavorable storage conditions such as warehouse storage at approximately 120° F. It has also been discovered that the clarity of the beverage can also be improved through the process of the present invention.

### Example 1

A non-limiting example of the process for preparing carbonated green tea with chile flavor is presented:
1) 350 ml of R.O. Water brought to a boil.
2) Add 7.8 ml of sweetener (sweetener=1 liter of 2M glucose+0.819 g Stevia Reb D)
3) Add 2 g of loose dried green tea leaves. Allow to boil for 1 minute before the addition of chile.
4) Allow to come to extraction temperature.
5) Add 20 g of Big Jim medium Green Chile (The chiles were roasted and frozen in the package. They were thawed, peeled and the stems removed before briefly pureeing in a food processor before weighing)
6) Allow mixture to remain at extraction temperature for an additional 7 minutes.
7) Remove heat and strain mixture using a stainless steel mesh sieve.
8) Filter mixture through a standard coffee filter into a sterilized plastic soda bottle with a capacity at least 20% greater than the volume produced.
9) Cap bottle and refrigerate overnight at ˜40° F.
10) Using a carbonater with a carbonation stone carbonated to 42 psi allow the bottle to sit for ˜1 min, then released the pressure. Repeat 2 more times.
11) Transfer carbonated tea to sterilized glass bottles and cap with sterilized crown caps.
12) Pasteurize filled bottles by heating them to water held between 165° F. and 180° F. for 10 min.
12) Allow filled bottle to cool.

### CONCLUSION

These results are believed to be applicable to other types of peppers produced by the present invention as well. These and other modifications and variations to the present invention may be practiced by those of ordinary skill in the art, without departing from the spirit and scope of the present invention. In addition, it should be understood that aspects of the various embodiments may be interchanged both in whole or in part.

Furthermore, those of ordinary skill in the art will appreciate that the foregoing description is by way of example only, and is not intended to limit the invention.

What is claimed:

1. A non-alcoholic sparkling beverage comprising, in addition to other ingredients, an extract of capasicum containing peppers obtained by a water extraction process at sub-boiling temperature.

2. The said non-alcoholic sparkling beverage of claim 1 is tea.

3. The said non-alcoholic sparkling beverage of claim 1 is soda.

4. The said non-alcoholic sparkling beverage of claim 1 is sparkling water.

5. The said non-alcoholic sparkling beverage of claim 1 is an energy drink.

6. The said non-alcoholic sparkling beverage of claim 1 is a sport/rehydration drink.

7. A process for the preparation of a flavor enhanced non-alcoholic sparkling beverage, comprising:
preparing a stock beverage;
extracting capsaicinoids and pepper-derived vitamins and phytochemicals using a water extraction method;
infusing said capsaicinoids and said pepper-derived vitamins and phytochemicals into said stock beverage to form flavor enhanced beverage;
filtering and purifying said flavor enhanced beverage to remove particulate matter;
bottling and carbonating said flavor enhanced beverage; and
pasteurizing said flavor enhanced beverage.

8. The process for the preparation of a flavor enhanced non-alcoholic sparkling beverage, in accordance with claim 7, wherein said stock beverage is tea.

9. The process for the preparation of a flavor enhanced non-alcoholic sparkling beverage, in accordance with claim 7, wherein said stock beverage is soda.

10. The process for the preparation of a flavor enhanced non-alcoholic sparkling beverage, in accordance with claim 7, wherein said stock beverage is water.

11. The process for the preparation of a flavor enhanced non-alcoholic sparkling beverage, in accordance with claim 7, wherein said stock beverage is an energy drink.

12. The process for the preparation of a flavor enhanced non-alcoholic sparkling beverage, in accordance with claim 7, wherein said stock beverage is a sport/rehydration drink.

13. The process for the preparation of a flavor enhanced non-alcoholic sparkling beverage, in accordance with claim 7, wherein the water based extracted capsaicinoids and pepper-derived vitamins and phytochemicals are added at a concentration of between 1-1000 SHU's units/20 grams.

14. The process for the preparation of a flavor enhanced non-alcoholic sparkling beverage, in accordance with claim 7, wherein said extracting step is performed between the temperatures of 60° F. and 212° F.

15. The process for the preparation of a flavor enhanced non-alcoholic sparkling beverage, in accordance with claim 14, wherein said extracting step is performed between the temperatures of 176° F. and 194° F.
